(19) United States
(12) Patent Application Publication
(10) Pub. No.: US 2005/0037740 A1
(43) Pub. Date: Feb. 17, 2005

(54) System and method for delivery of multimedia content into end-user devices

(76) Inventors: Sunny P. Smith, Kechi, KS (US); David A. Raehpour, Wichita, KS (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/626,619

(22) Filed: Jul. 25, 2003

(51) Int. Cl. H04M 3/42

(52) U.S. Cl. 455/414.1

(57) ABSTRACT

An multimedia content interface system, computer program product, and method of operation provides multimedia content to a user without the user having to use a computer system, or other computation device. A multimedia content interface system for providing multimedia content stored on a data communications network to an end-user over another network, the multimedia content interface system communicatively connected to the data communications network and the other network, comprises a media delivery interface module operable to interface with the end-user over the other network, accept a request for multimedia content from the end-user, access multimedia content over the data communications network, and provide the multimedia content to the end-user over the other network and a content address translation module operable to provide an address mapping between an address of multimedia content stored on the data communications network and an address of the end-user on the other network.

### FIELD OF THE INVENTION

The present invention relates to a system, method, and computer program product for providing multimedia content stored on a data communications network to an end-user over a telecommunications network.

### BACKGROUND OF THE INVENTION

As the Internet has grown, a number of Internet media functions have become popular. One such function is the provision of streaming multimedia content from a Web site to a user browsing that Web site using a computer system and a browser program. For example, a user may browse to a Web site and obtain live or recorded streaming multimedia content of many events or performances. However, this functionality requires the use of a computer system, or other computation device, which is communicatively connected to the Internet. It is not always practical for a user to possess such equipment. Thus, a need arises for a technique by which a user may obtain multimedia content without the user having to use a computer system, or other computation device.

### SUMMARY OF THE INVENTION

The present invention provides multimedia content to a user without the user having to use a computer system, or other computation device.

In one embodiment of the present invention, a multimedia content interface system for providing multimedia content stored on a data communications network to an end-user over another network, the multimedia content interface system communicatively connected to the data communications network and the other network, comprises a media delivery interface module operable to interface with the end-user over the other network, accept a request for multimedia content from the end-user, access multimedia content over the data communications network, and provide the multimedia content to the end-user over the other network and a content address translation module operable to provide an address mapping between an address of multimedia content stored on the data communications network and an address of the end-user on the other network.

In one aspect of the present invention, the other network may comprise a telecommunications network and the multimedia content is provided to the end-user over a voice channel of the telecommunications network. The telecommunications network may comprise at least one of a Public Switched Telephone Network (PSTN), a proprietary local telecommunications network, and a proprietary long distance telecommunications network. The telecommunications network may comprise at least one of a wireless telecommunications network and a wireline telecommunications network. The telecommunications network may comprise at a wireless telecommunications network and a wireline telecommunications network, which are interconnected.

In one aspect of the present invention, the end-user operates an end-user device including at least one of a telephone station and an Internet protocol capable device.

In one aspect of the present invention, the end-user operates an end-user device including at least one of a wireless telephone station, a wired telephone station, a personal digital assistant, and a laptop computer.

In one aspect of the present invention, the media delivery interface module is further operable to perform the steps of receiving a telephone call from the end-user, presenting a user interface to the end-user, accepting a selection of multimedia content from the end-user and providing the selected multimedia content to the end user. The step of presenting a user interface to the end-user may comprise the step of presenting a different user interface, multimedia content selections, and/or multimedia content to the end-user based on a telephone number dialed by the end-user to place the telephone call. The step of providing the selected multimedia content to the end user may comprise the steps of requesting the selected multimedia content over the data communications network from a source of multimedia content using an indicator of a location of the multimedia content, receiving over the data communications network the requested multimedia content, and providing the requested multimedia content to the end-user over the other network.

In one aspect of the present invention, there is a plurality of end-users requesting the same multimedia content and the step of providing the selected multimedia content to the end-user comprises the step of providing the multimedia content to all end-users that requested the multimedia content. The requested multimedia content may be live multimedia content and the step of providing the multimedia content to all end-users that requested the multimedia content may comprise the step of providing the multimedia content to an end-user from a point in the multimedia content at which the end-user requested the multimedia content. The requested multimedia content may be recorded multimedia content and the step of providing the multimedia content to all end-users that requested the multimedia content may comprise the steps of providing the multimedia content to an end-user from a point in the multimedia content at which the end-user requested the multimedia content and repeating providing the multimedia content from the start of the multimedia content. The requested multimedia content may be recorded multimedia content and the step of providing the multimedia content to all end-users that requested the multimedia content may comprise the step of providing the multimedia content from the start of the multimedia content for each end-user that requests the multimedia content.

In one aspect of the present invention, the step of presenting a user interface to the end-user further comprises the step of presenting a different user interface, multimedia content selections, and/or multimedia content to the end-user based on a telephone number from which the end-user placed the telephone call. The step of presenting a user interface to the end-user may comprise the step of presenting a personalized content selection. The step of presenting the personalized content selection may comprise the step of presenting the personalized content selection based on a telephone number from which the end-user placed the telephone call. The step of presenting the personalized content selection may comprise the step of presenting the personalized content selection based on a telephone number dialed by the end-user to place the telephone call. The step of presenting the personalized content selection may comprise the step of presenting the personalized content selection based on a telephone number dialed by the end-user to place the telephone call. The system may be further operable to perform the step of providing the capability for the end-user to manage the personalized content selection. The step of providing the capability for the end-user to manage the personalized content selection may comprise the step of providing the capability for the end-user to manage the personalized content selection over the data communications network. The data communications network may be the Internet.

In one aspect of the present invention, the media delivery interface module is further operable to perform the step of controlling access and/or input to the media delivery interface module. The step of controlling access and/or input to the media delivery interface module may comprise at least one of providing password control to establish origination connections; metering to control, limit, and/or bill based on a length or size of the multimedia content, a number of simultaneous accesses to the multimedia content, a number of total accesses to the multimedia content, a time of access to the multimedia content, and/or periodic charges; limiting input sources to hardwired connections; accept connection only from designated sources; controlling which pieces of content are available based on an access method, login, and/or interconnect; importing an external permissions file; providing a sample multimedia content, then requiring billing information to continue providing multimedia content; blocking specific calling numbers automatically after sample multimedia content has been provided, until payment is made; and blocking specific calling numbers permanently.

In one aspect of the present invention, the media delivery interface module is further operable to perform the step of providing advertising content to the end-user. The step of providing advertising content to the end-user may comprise at least one of providing advertising content by class of service, providing advertising content based on selected multimedia content, providing advertising content before and/or after providing selected multimedia content, and providing advertising content based on a timed advertising interval.

In one aspect of the present invention, the media delivery interface module is further operable to perform the step of requesting the selected multimedia content from a Web server. The step of the requesting the selected multimedia content from a Web server may comprise the step of requesting the selected multimedia content from the Web server using a uniform resource locator. The data communications network may be the Internet.

In one aspect of the present invention, the media delivery interface module is further operable to perform the step of requesting the selected multimedia content from a multimedia content server. The step of the requesting the selected multimedia content from the multimedia content server may comprise the step of requesting the selected multimedia content from the multimedia content server using a uniform resource locator. The data communications network may be the Internet.

In one aspect of the present invention, the system further comprises a media acceptance/conversion module operable to provide a physical interface for a plurality of multimedia content feeds and to convert an incoming format of each multimedia content feed into an internal media format. A multimedia content feed may comprise proprietary content or content not available on the Internet and the system is operable to interface the multimedia content feed through the media acceptance/conversion module for conversion of an incoming format of the multimedia content feed into an internal media format and to relay the converted multimedia content feed to the media delivery interface module for delivery to the end user. The incoming format of the multimedia content feed includes at least one of analog voice, digital voice, dial-up telephony via a voice response unit, and Internet Protocol streaming media protocols.

A multimedia content feed may comprise publicly available Internet content and the system is operable to deliver the multimedia content directly to the media delivery interface module for delivery to the end user.

A multimedia content feed may comprise publicly available Internet content and the system is operable to interface the multimedia content feed through the media acceptance/conversion module for conversion of an incoming format of the multimedia content feed into an internal media format and to relay the converted multimedia content feed to the media delivery interface module for delivery to the end user if there are capacity limitations on a source the multimedia content feed, if there are cost advantages, or if the multimedia content is to be stored for future use.

In one aspect of the present invention, the system further comprises a media storage module operable to provide temporary storage for multimedia content that is to be stored for future use. A multimedia content feed may comprise multimedia content to be stored for future use and the system is operable to interface the multimedia content feed through the media acceptance/conversion module for conversion of an incoming format of the multimedia content feed into an internal media format, to store the converted multimedia content in the media storage module, to retrieve the converted multimedia content from the media storage module, and to deliver the retrieved converted multimedia content to the media delivery interface module for delivery to the end user.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a network system 100 in which the present invention may be implemented.

FIG. 2 is an exemplary data flow diagram of the multimedia content interface system shown in FIG. 1.

FIG. 3 is an exemplary block diagram of the multimedia content interface system shown in FIG. 1.

FIG. 4 is an exemplary block diagram of the multimedia content interface system shown in FIG. 1.

FIG. 5 is an exemplary flow diagram of a process of operation of the media delivery interface shown in FIG. 3.

### DETAILED DESCRIPTION OF THE INVENTION

The present invention is a system, method, and computer program product that delivers streaming multimedia content to telephone handsets or other devices connected to a telecommunications or telephony network. The present invention uses various address protocols that allow the end-user to choose which piece of content to receive. The content can then be delivered through a traditional telephony voice channel to the end-user device, such as a traditional fixed telephone or a wireless mobile handset. The present invention can acquire the content directly from the public Internet or via a direct feed over a private intranet. This acquired content is then patched into the voice channel of a user's telephone call. In order to deliver this, the present invention accepts content in one format from one network type and delivers it to another format and/or network type. In this environment users identify the content they want, and it is delivered with no-hassle. The user never needs to know whether the original content was based on the Internet, the telephone network, or some other origin. The present invention thus provides seamless access to content. Likewise, the content originators do not need to worry about the access methods of their end-users. One hand-off to the present invention enables many different end-users to receive the content. The present invention will perform protocol conversions such that the source of any specific piece of content is invisible to the user.

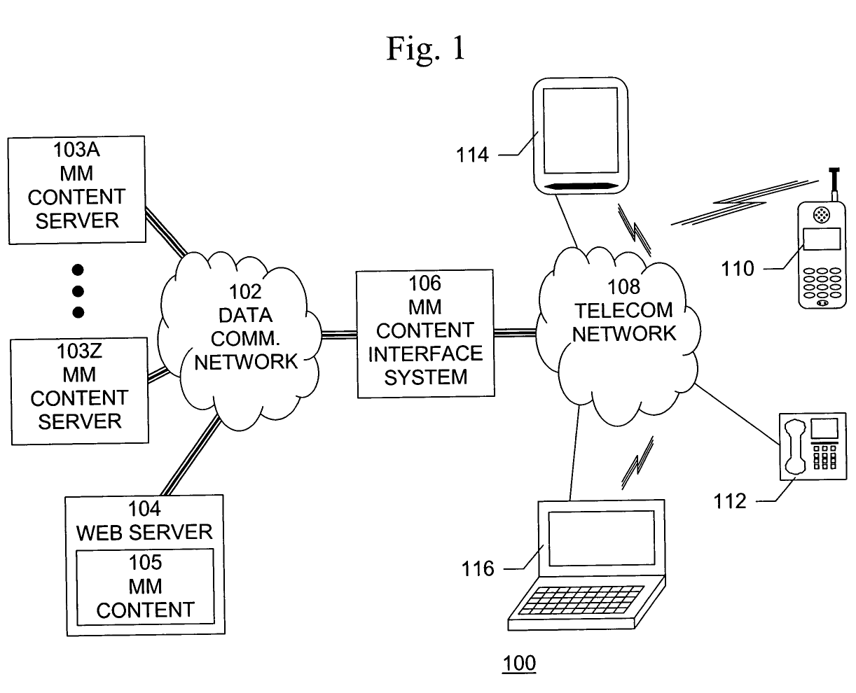

An exemplary block diagram of a network system 100 in which the present invention may be implemented is shown in FIG. 1. Network system 100 includes data communication network 102. Network 102 provides communicative interconnection of a plurality of devices, such as multimedia content servers 103A-Z. Multimedia content servers 103A-Z store multimedia content in digital form and transmit requested multimedia content over network 102. Typically, a multimedia content server is implemented as included functionality in another server, such as an Internet Web server, such as Web server 104. Web server 104 includes multimedia content 105 and transmits requested portions of multimedia content 105 over network 102.

Network 102 may include both wireless and wireline networks interconnected as appropriate. The transmission medium in a wireless network is typically electromagnetic radiation, such as radio waves or light. The transmission medium in a wireline network is typically copper cable or fiber optic cable. Network 102 may include one or more local area networks (LANs), one or more wide area networks (WANs), or both LANs and WANs. One or more networks may be included in network 102 and may include both public networks, such as the Internet, and private networks and may utilize any networking technology and protocol, such as Ethernet, Token Ring, Transmission Control Protocol/Internet Protocol (TCP/IP), etc. Although not shown in FIG. 1, network 102 may connect, interconnect, or interface with one or more other wireless networks or with one or more wireline networks.

Also connected to network 102 is multimedia content interface system 106, which interfaces network 102 with telephony network 108. Telecommunications network 108 may include, for example, the Public Switched Telephone Network (PSTN), as well as proprietary local and long distance telecommunications networks. The PSTN and the proprietary telecommunications networks may include wireless and wireline networks interconnected as appropriate. A plurality of end-user devices, such as telephone stations that are typically operated by an end-user, for example, wireless telephones, such as wireless telephone station 110, and wired telephones, such as wired telephone station 112, may be communicatively connected to telecommunications network 108. Likewise, other end-user devices, such as Internet protocol (IP) capable devices, for example, computing devices such as personal digital assistant 114 and laptop computer 116, may be communicatively connected by wireless and/or wired communications channels. In addition, the present invention contemplates use with any other type of device that is capable of being communicatively connected by wireless and/or wired communications channels to telecommunications network 108.

Multimedia content interface system 106 provides delivery of multimedia content into telephony devices, such as telephone stations 110 and 112, Internet protocol (IP) capable devices, for example, computing devices such as personal digital assistant 114 and laptop computer 116, as well as desktop computers, and any other type of device that is capable of being communicatively connected by wireless and/or wired communications channels to telecommunications network 108. Multimedia content interface system 106 delivers streaming multimedia traffic from a data communications network, such as the Internet, to the telephony network. For example, streaming audio Internet content may be delivered to telephone handsets or other devices connected to the telephony network.

It is to be noted that telecommunications network 108 may include a plurality of communications delivery technologies, particularly in when connected to wireless telephone station 110. All telephone stations are provided with a voice channel or connection (either analog or digital) to telecommunications network 108. In addition, telecommunications network 108 may provide data communications delivery technologies, such as Wireless Access Protocol (WAP), which provide the capability for connected devices to communicate data, such as with the Internet, local area networks, etc. The present invention is compatible with the delivery of streaming multimedia traffic to telephone handsets or other devices connected to the telephony network using any of these communications delivery technologies.

However, in a preferred embodiment, the present invention uses a voice channel (either analog or digital) to deliver streaming audio traffic to telephone handsets or other devices connected to the telephony network. The use of the voice channel provides the advantage that the present invention works with all telephone handsets, since all telephone handsets, wired or wireless, possess a voice channel. By contrast, only wireless handsets may possess data communications delivery technologies, and only a relatively small percentage of wireless handsets possess these technologies. Another advantage of using the voice channel is that the present invention operates on significantly less wireless bandwidth, which means significantly lower cost to the wireless provider.

Multimedia content interface system 106 uses various address protocols that allow the end-user to choose the piece of content to receive. The content selected can be acquired from the public Internet or via a direct feed over a private intranet. The present invention can acquire the content directly from the public Internet or via a direct feed over a private intranet. This acquired content is then patched into the voice channel of a user's telephone call. In order to deliver this, the present invention accepts content in one format from one network type and delivers it to another format and/or network type. In this environment users identify the content they want, and it is delivered automatically. Multimedia content interface system 106 performs protocol conversions such that the source of any specific piece of content is invisible to the user.

Multimedia content interface system 106 supports multiple simultaneous end-users. Each end-user will be delivered the content of their choice. Although end-users can request unrelated pieces of content, the same content can also be requested by more than one end-user.

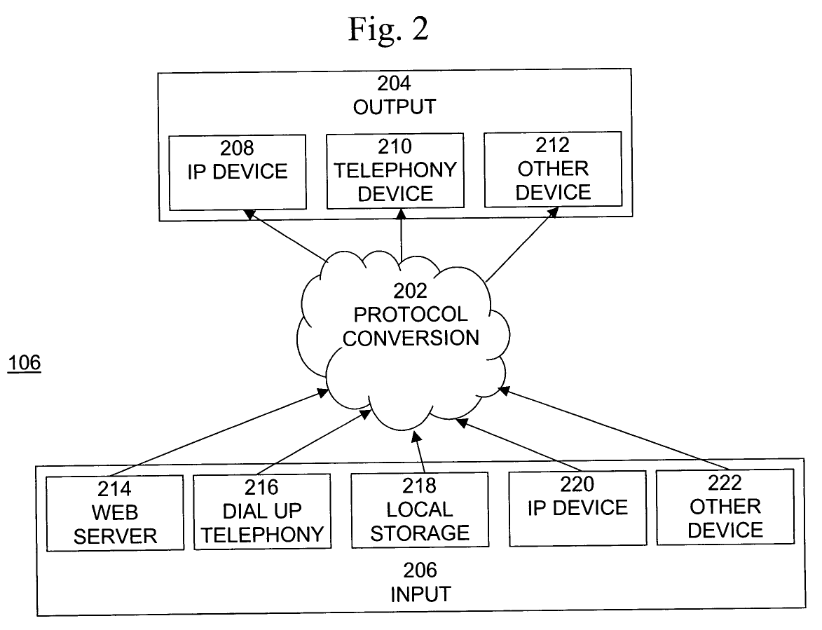

An exemplary data flow diagram of multimedia content interface system 106 is shown in FIG. 2. System 106 includes protocol conversion module 202, output device protocols 204, and input device protocols 206. Output device protocols 204 may include protocol support for IP or other data communication protocol capable devices 208, telephony devices 210, and other devices 212. Input device protocols 206 may include protocol support for Web servers 214, dialup telephony devices 216, local storage devices 218, IP devices 220, and other devices 222. IP devices may include Internet protocol (IP) or other protocol capable devices, for example, computing devices such as PDAs, laptop computers, desktop computers, and other information processing and/or computing systems. Telephony devices may include wired and wireless telephone stations and other telephony devices. Web servers may include general purpose Web servers and dedicated multimedia content servers.

Input device protocols 206 may include support for additional multimedia protocols, such as feeds from the telephone network using dialup access, or from any IP (Internet Protocol) capable device. This IP device could be anything from a web server to a home computer connected to the Internet to a special purpose content origination device. Any incoming feed can be recorded/saved. Since local storage is another playback alternative, the saved information can be broadcast at a later date.

Output device protocols 204 may include support for alternative output formats. The end-user can access the system using traditional handsets, using wireless mobile handsets, or using any other device attached to a telephone network. The content can also be accessed through IP devices, such as personal computers, attached to the public Internet and through end user devices operating on other formats.

System 106 supports multiple simultaneous end-users. Each end-user can be connected to any content they request. This allows any specific piece of content to be shared among one or more users. Each end-user can access the same or different content relative to every other user on the system. This allows two different users to access the same multimedia content at the same time using different access devices. It also allows simultaneous users to access different pieces of content.

In order to support these access alternatives, the system 106 can retrieve the information using various protocols. It also allows subsets of its content to be accessed using different access protocols than other subsets.

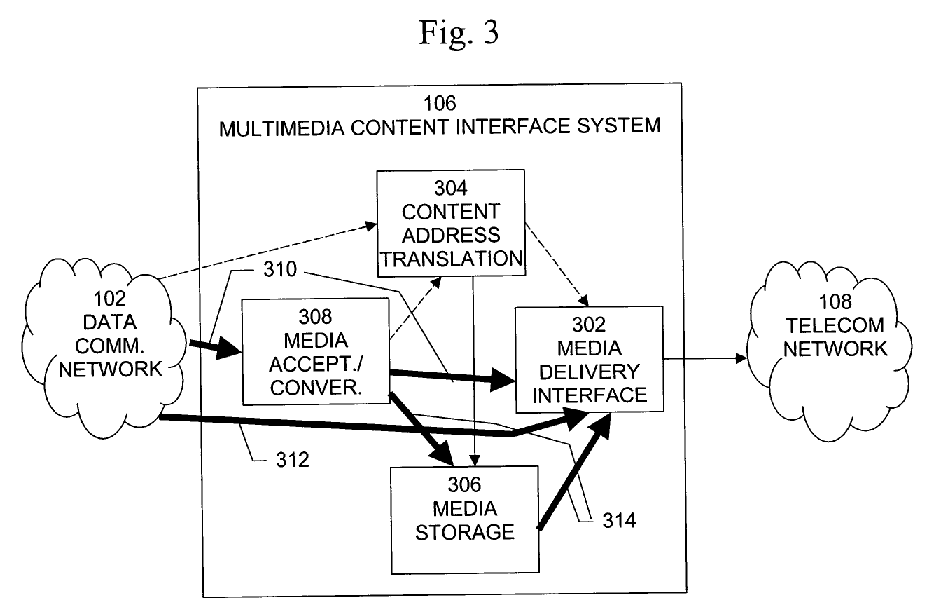

An exemplary block diagram of multimedia content interface system 106 is shown in FIG. 3. System 106 includes media delivery interface module 302, content address translation module 304, media storage module 306, and media acceptance/conversion module 308. The present invention contemplates that each module may be implemented in a variety of ways. For example, each module may be implemented on its own dedicated hardware, or all modules may be implemented on a single shared server. If separate servers are involved the servers may be physically co-located or they may be geographically dispersed and tied through dedicated circuits, data networks, and/or the public Internet. Depending on the format of the incoming content and the format of the outgoing content, the role of each of the modules may vary. However, this variance is internal to the system. The user's access to the content will be consistent no matter what source is used for the content. For example, an end-user can use any telephony device such as a mobile handset to call into the product. During this call, the end-user can request a specific piece of content. This content will be played over the handset to the user. The user will not need to know how the content was put into the system.

Media Delivery Interface (MDI) module 302 provides an interface to a telecom network, such as telecom network 108, shown in FIG. 1, that links to the end-user. The end-user dials a telephone number to access MDI 302. MDI 302 supports multiple incoming telephone numbers. Based on the number that is dialed, MDI 302 can present a different user interface and/or a different set of content. It is possible to have a phone number associated with only one piece of content. In this case, the content can begin playing as soon as the system answers the phone. On the other hand, there is no upper limit on the number of pieces of content that can be accessed via a single dial-in number. The issue with large sets of content is in developing a user interface that allows users to easily select one piece of content from a large library. As is discussed later, the product has many different means of indexing and addressing content in order to simplify these user interface issues.

MDI 302 only provides the end-user interface. It does not originate content. Content is streamed into MDI 302, for example, from one or more multimedia content servers 103A-Z and/or web server 104, when it is requested by the user. Associated with each piece of content requested is a URL. MDI 302 uses this URL to request the streaming content over the network.

If a requested piece of content is already delivered to MDI 302, the new end-user will be connected to the existing content feed. The system will not request two copies of the same content. However, there are two types of content that could be selected: Live or recorded. ‘Live’ content is connected once to MDI 302 and shared among all users. Recorded content can be treated differently. Recorded content could be static content from outside the MDI 302, such as interview saved on the Internet. It also could be content saved in the MDI 302 for later playback. MDI 302 has three different methods for handling recorded content: Looping, Unique, and Live. “Looping” playback is played in a repeating loop. If looping content is streaming to the platform, then any new user requests will be connected to the existing stream even though the content replay is already in progress. At the end of the selection, the content will automatically begin repeating as long as at least one listener is still listening. This allows users who have joined in mid-stream to listen to anything they have missed in the beginning.

“Unique” playback gives a new audio stream to each user who requests the content. This allows each user to hear the entire passage from start to finish, but it may be resource intensive.

“Live” playback is played similar to live content. Any new user is attached to the audio stream that is already in progress. The content will not automatically be repeated when it is completed. This means that the user will miss any content that has been played when they join the conversation.

The type of playback can be set for each content item. However, the administrator can also specify a default type. All items with no playback type will be assigned the default type. The default must be either Unique or Live and the default playback will be assigned to live as well as stored content.

Content Address Translation (CAT) module 304 provides an address map between the various content locations and the differing access methods. For example, a live audio feed could be listened to on a telephone and on the Internet. This system is used to manage and relate the different addresses used in each case.

The telephony mapping system is especially critical. It can be hard for a casual user to access specific information using only a touch-tone interface. Several mechanisms will be used to ease access:

In some cases available content will be limited to a selected set of multimedia streams based on the telephone number used to call the service. This supports the ability to publish a single number that accesses a targeted subset of content. At its extreme, a single content stream will be matched to a dedicated number. This allows end-users who dial the number to immediately hear the content stream. This will also allow easy access to small content subsets. For example, dialing a number to access 30 event-related streams results in a manageable content choice that the user can navigate through using a menu.

In other cases, users will dial numbers that access a larger content library. The user could navigate to selected content using a keyword or numeric index. In order to make the keyword navigation simpler, the system could employee continuous voice recognition with keyword spotting.

The user could also access a personalized content selection. When the user dials into the system they would be identified by either the phone number/DNIS of the originating calling device, or by entering a personal identification code when they dial in. This personalized selection system is managed directly by the user through an Internet interface. The user can log in and choose content to be received over the telephone network, and assign personal speed dial numbers to those content items. Alternatively, the user can build a custom login menu using text to speech.

With callback content delivery the system can also deliver content to other devices, such as broadband pagers, that have voice reception capability.

In fact, this ability to create personal content bookmarks would allow users to also bookmark content that is on the public Internet, and that is completely outside the product platform. When a user accesses one of these personal bookmarks, the system will retrieve the content from the public Internet and convert it as necessary for delivery to the end-user.

The user can schedule future delivery of content to a telephone number using the Internet. At a designated future time, the system will call the user and play the pre-selected piece of content. This is useful in the case of events in that it serves as both content delivery and reminder of the event while making the content easy to access. When the selected time arrives, the system automatically calls the user and the content is automatically presented with no menus required. Some stored content is played on a continuous loop. With continuous, stored content, the system can call the user immediately before the content begins to repeat.

Wireless Internet and/or 3G wireless technologies will allow simultaneous circuit switched and data access to the product platform. This allows the possibility of multi-mode approaches wherein the menu systems can be delivered visually and the media content can be delivered either via circuit switched channels or data channels.

CAT 304 also provides an Internet interface to the content. It allows users to log onto an Internet site and use an index of current content to select content to be played through the user's web browser and its plugins.

Media Acceptance/Conversion (MAC) module 308 provides the physical interface for various content feeds and it has conversion software to convert the incoming format into the internal media format of the product. Media Storage (MS) module 306 provides temporary storage for media streams that are to be stored for future use, such as those that will be delivered in the future.

There are three possible delivery paths for the actual content in the system, as shown in FIG. 3. In large part these delivery paths depend on the content format and point of origination.

Path 310 handles proprietary content or content not available on the public Internet. This content is interfaced through the Media Acceptance/Conversion (MAC) module 308. MAC 308 provides the physical interface for various content feeds and it has conversion software to convert the incoming format into the internal media format of the product. This content is then relayed to the appropriate MDI 302 for delivery to the customer. Examples of input protocols include traditional analog voice, digital voice, dial-up telephony via a Voice Response Unit, and IP streaming media protocols.

Path 312 handles publicly available Internet content. Although the system handles address translation and address aliasing, it may not be necessary to carry this content over the internal system network. These content items can be delivered through an Internet connection directly to the MDI 302 where it can be sent to the end user. However, in several circumstances this content may be delivered through the MAC 308. These include:
1. Capacity limitations on the public source, such that it is not able to handle the volume of end-user requests.
2. Potential cost advantages: 3rd party software and transmission costs may be related to the number of independent media streams delivered. In the case where multiple MDI units are requesting a media stream, it may be advantageous to consolidate the streams into one system stream that the product then distributes throughout its network.
3. The desire to store the content for future use. In this case, the content may be delivered through the MAC so that it can be routed to the media storage (MS) device 306.

Path 314 handles content to be stored for later use, which is routed through MAC 308, where it will be sent to MS 306 for storage. When an end-user requests the content it will be retrieved from the MS 306 and sent to MDI 302.

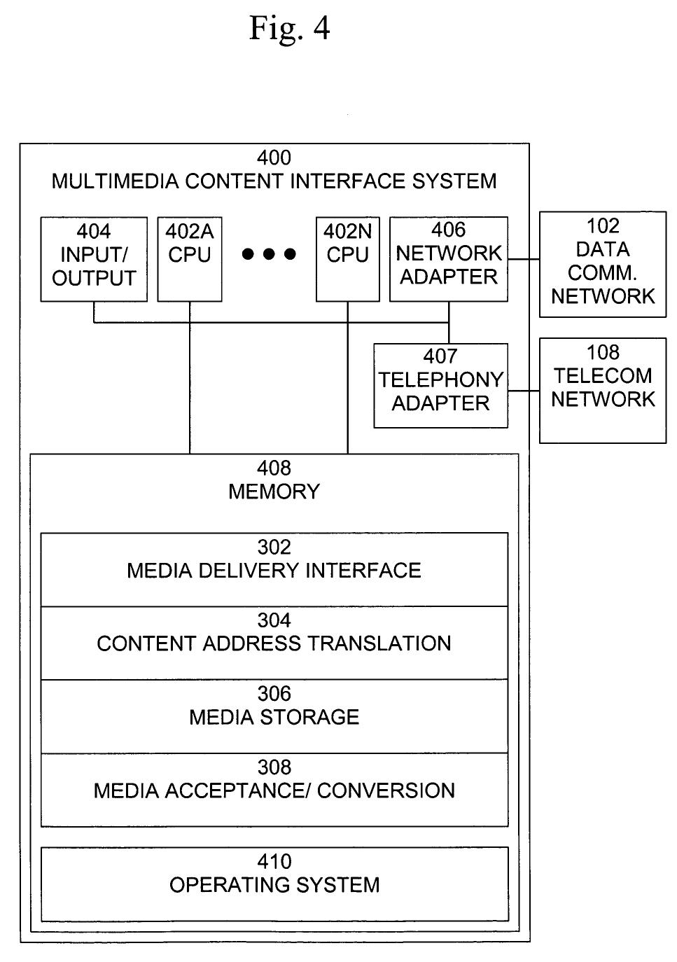

An exemplary block diagram of a multimedia content interface system 106 is shown in FIG. 4. System 106 is typically a programmed general-purpose computer system, such as a personal computer, workstation, server system, and minicomputer or mainframe computer. System 106 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which system 106 is implemented as a single multi-processor computer system, in which multiple processors 402A-402N share system resources, such as memory 408, input/output circuitry 404, and network adapter 406. However, the present invention also contemplates embodiments in which system 106 is implemented as a plurality of networked computer systems, which may be single-processor computer systems, multi-processor computer systems, or a mix thereof.

Input/output circuitry 404 provides the capability to input data to, or output data from, system 106. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces system 106 with data communications network 102. Data communications network 102 may include one or more standard local area network (LAN) or wide area network (WAN), such as Ethernet, Token Ring, the Internet, or a private or proprietary LAN/WAN. Telephony adapter 407 interfaces system 106 with telecommunications network 108. Telecommunications network 108 may include, for example, the Public Switched Telephone Network (PSTN), as well as proprietary local and long distance telecommunications networks. The PSTN and the proprietary telecommunications networks may include wireless and wireline networks interconnected as appropriate.

Memory 408 stores program instructions that are executed by, and data that are used and processed by, CPU 402 to perform the functions of system 106. Memory 408 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 4, memory 408 includes media delivery interface module 302, content address translation module 304, media storage module 306, and media acceptance/conversion module 308, and operating system 410. Media Delivery Interface (MDI) module 302 provides an interface to a telecom network, such as telecom network 108, shown in FIG. 1, that links to the end-user. Content Address Translation (CAT) module 304 provides an address map between the various content locations and the differing access methods. Media Acceptance/Conversion (MAC) module 308 provides the physical interface for various content feeds and it has conversion software to convert the incoming format into the internal media format of the product. Media Storage (MS) module 306 provides temporary storage for media streams that are being delivered, or which will be delivered in the near future. Operating system 428 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

Multimedia content interface system 106 may operate on a single hardware platform, or one or more modules may operate on separate platforms. In a distributed environment, the MDI units could be spread throughout a geographic region so that end-users can have a local access point.

Each MDI can distribute a single media feed to all of its end-users who desire the feed. However, in order to achieve full geographic coverage, the same media stream would need to be sent to each MDI that served users who desired the content.

In general the product network will use a common format for routing media among network elements. This format will support continuous media streaming such that, after initial buffering, the content can begin playing at the recipient side even as it is still be transmitted and/or retrieved at the sending node. Where economically feasible the system can use industry standard and 3rd party streaming solutions. However, if necessary the product will support a proprietary network for inter-nodal media delivery. This protocol may also support multi-cast delivery so that the originating node can send one media stream and have it received by multiple recipient nodes.

The system may include various options of controlling access and input to the system. These access control options can be tied to an internal or external billing database. Alternatives for input control may include any or none of the following:
Password control to establish origination connections
Metering to control/limit/bill based on
   Length/size of content stream
   Number of simultaneous accesses
   Number of total accesses
   Total Access Minutes
   Storage Used per Time Period
   Time based subscription fees (weekly, monthly, yearly)
Potential to limit input sources to hardwired connections. Only accept connection from designated sources (IP addresses, URLs, etceteras)
Ability to control which pieces of content are available/tied to a given access method/login/interconnect
Alternatives for end-user access may include any of the methods listed above with the goal of controlling access and potentially linking billing options to access control.
Ability to import external permissions files.
Ability to play sample ‘teaser’ then to request billing information to continue.
Ability to block specific calling numbers automatically after teaser has been played until payment is made.
Ability to block specific calling numbers on a permanent basis.
Advertising

The system may also include the ability to introduce paid advertising into the process. Two types of advertising that could be supported are advertising on the web while accessing CAT 304 interface, and in the actual multi-media stream. Web/CAT advertising would appear just as standard web advertising. However, the in-stream version of the advertising may include several special features:
Ability to schedule advertising content by class of service for improved targeting.
Ability to schedule advertising by specific content item.
Ability to insert advertising before content plays and/or after content plays.
Ability to insert advertising in stream based on a timed advertising interval.

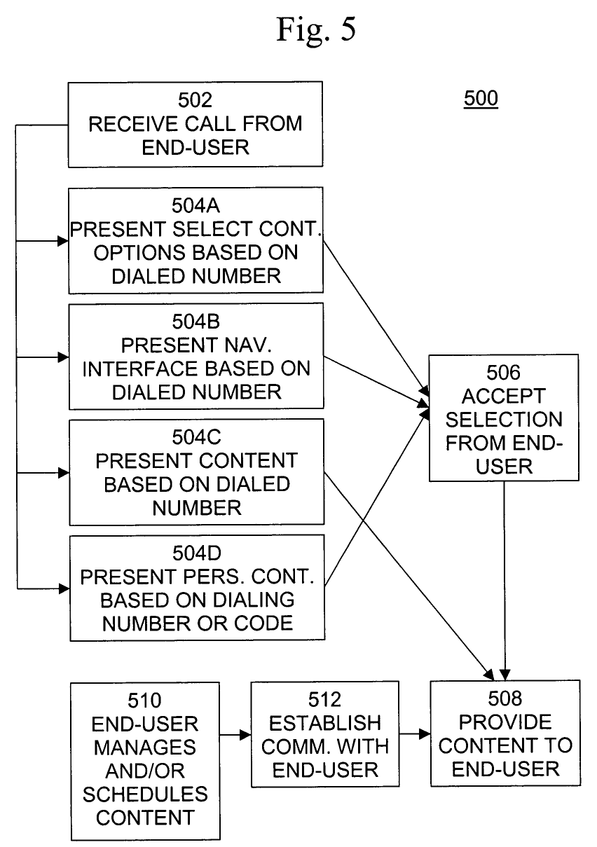

A process of operation 500 of media delivery interface (MDI) 302, shown in FIG. 3, is shown in FIG. 5. Process 500 begins with step 502, in which a call is received from an end-user, who dials a telephone number to access MDI 302. MDI 302 supports multiple incoming telephone numbers. Based on the number that is dialed, MDI 302 can present a different user interface and/or a different set of content. Some examples of this are shown by alternate steps 504A, 504B, 504C, and 504D, which may be selected for performance based on the number, dialed by the end-user to access MDI 302. In step 504A, multimedia content selections are presented to the end-user based on the number dialed by the end-user to access MDI 302. In step 504B, a navigation interface providing access to a larger library of multimedia content selections is presented to the end-user based on the number dialed by the end-user to access MDI 302. For example, the user could navigate to selected content using a keyword or numeric index. In order to make the keyword navigation simpler, the system could employee continuous voice recognition with keyword spotting. In step 504C, multimedia content not requiring selection is presented to the end-user based on the number dialed by the end-user to access MDI 302. It is possible to have a phone number associated with only one piece of content. For example, in this case, the content can begin playing as soon as the system answers the phone. On the other hand, there is no upper limit on the number of pieces of content that can be accessed via a single dial-in number. In step 504D, a personalized content selection is presented to the end-user based on the telephone number from which the user placed the call or based on a code entered by the user. When the user dials into the system, the user would be identified by either the phone number/DNIS of the originating calling device, or by entering a personal identification code when they dial in. The user could then select the desired content from among the presented personalized content selections.

If step 504A, step 504B, step 504D, or another step not shown that requires input from the end-user, was performed, process 500 continues with step 506, in which the input or selection from the end-user is accepted. The process then continues with step 508, in which the selected content is provided to the end-user by using the functionality of the content address translation module 304, shown in FIG. 3.

If step 504C, or another step not shown that does not require input from the end-user, was performed, process 500 continues with step 508, in which the selected content is provided to the end-user by using the functionality of the content address translation module 304, shown in FIG. 3. In this case, the content is selected only based on the number dialed by the end-user to access MDI 302, and not on any end-user selections made after the call is connected to MDI 302.

In step 510, the end-user manages and/or schedules content. For example, the user may manage the personalized content selection provides in step 504D through an Internet interface. The user can log in and choose content to be received over the telephone network, and assign personal speed dial numbers to those content items. Alternatively, the user can build a custom login menu using text to speech. As another example, the user can schedule future delivery of content to a telephone number or other devices using the Internet.

In step 512, at a designated time, either immediately or in the future, system 106 will call the user and play a pre-selected piece of content. This is useful in the case of events in that it serves as both content delivery and reminder of the event while making the content easy to access. When the selected time arrives, the system automatically calls the user and the content is automatically presented with no menus required. Some stored content is played on a continuous loop. With continuous, stored content, the system can call the user immediately before the content begins to repeat.

With callback content delivery the system can also deliver content to other devices, such as broadband pagers, that have voice reception capability.

In fact, this ability to create personal content bookmarks would allow users to also bookmark content that is on the public Internet, and that is completely outside the product platform. When a user accesses one of these personal bookmarks, the system will retrieve the content from the public Internet and convert it as necessary for delivery to the end-user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A multimedia content interface system for providing multimedia content stored on a data communications network to an end-user over another network, the multimedia content interface system communicatively connected to the data communications network and the other network, comprising:
a media delivery interface module operable to interface with the end-user over the other network, accept a request for multimedia content from the end-user, access multimedia content over the data communications network, and provide the multimedia content to the end-user over the other network; and
a content address translation module operable to provide an address mapping between an address of multimedia content stored on the data communications network and an address of the end-user on the other network.

2. The system of claim 1, wherein the other network comprises a telecommunications network and the multimedia content is provided to the end-user over a voice channel of the telecommunications network.

3. The system of claim 2, wherein the telecommunications network comprises at least one of a Public Switched Telephone Network (PSTN), a proprietary local telecommunications network, and a proprietary long distance telecommunications network.

4. The system of claim 2, wherein the telecommunications network comprises at least one of a wireless telecommunications network and a wireline telecommunications network.

5. The system of claim 2, wherein the telecommunications network comprises at a wireless telecommunications network and a wireline telecommunications network, which are interconnected.

6. The system of claim 1, wherein the end-user operates an end-user device including at least one of a telephone station and an Internet protocol capable device.

7. The system of claim 1, wherein the end-user operates an end-user device including at least one of a wireless telephone station, a wired telephone station, a personal digital assistant, and a laptop computer.

8. The system of claim 1, wherein the media delivery interface module is further operable to perform the steps of:
receiving a telephone call from the end-user;
presenting a user interface to the end-user;
accepting a selection of multimedia content from the end-user; and
providing the selected multimedia content to the end user.

9. The system of claim 8, wherein the step of presenting a user interface to the end-user comprises the step of:
presenting a different user interface, multimedia content selections, and/or multimedia content to the end-user based on a telephone number dialed by the end-user to place the telephone call.

10. The system of claim 9, wherein the step of providing the selected multimedia content to the end user comprises the steps of:
requesting the selected multimedia content over the data communications network from a source of multimedia content using an indicator of a location of the multimedia content;
receiving over the data communications network the requested multimedia content; and
providing the requested multimedia content to the end-user over the other network.

11. The system of claim 10, wherein there are a plurality of end-users requesting the same multimedia content and the step of providing the selected multimedia content to the end-user comprises the step of:
providing the multimedia content to all end-users that requested the multimedia content.

12. The system of claim 11, wherein the requested multimedia content is live multimedia content and the step of providing the multimedia content to all end-users that requested the multimedia content comprises the step of:
providing the multimedia content to an end-user from a point in the multimedia content at which the end-user requested the multimedia content.

13. The system of claim 11, wherein the requested multimedia content is recorded multimedia content and the step of providing the multimedia content to all end-users that requested the multimedia content comprises the steps of:
providing the multimedia content to an end-user from a point in the multimedia content at which the end-user requested the multimedia content; and
repeating providing the multimedia content from the start of the multimedia content.

14. The system of claim 11, wherein the requested multimedia content is recorded multimedia content and the step of providing the multimedia content to all end-users that requested the multimedia content comprises the step of:
providing the multimedia content from the start of the multimedia content for each end-user that requests the multimedia content.

15. The system of claim 9, wherein the step of presenting a user interface to the end-user further comprises the step of:
presenting a different user interface, multimedia content selections, and/or multimedia content to the end-user based on a telephone number from which the end-user placed the telephone call.

16. The system of claim 8, wherein the step of presenting a user interface to the end-user comprises the step of:
presenting a personalized content selection.

17. The system of claim 16, wherein the step of presenting the personalized content selection comprises the step of:
presenting the personalized content selection based on a telephone number from which the end-user placed the telephone call.

18. The system of claim 16, wherein the step of presenting the personalized content selection comprises the step of:
presenting the personalized content selection based on a telephone number dialed by the end-user to place the telephone call.

19. The system of claim 16, wherein the step of presenting the personalized content selection comprises the step of:
presenting the personalized content selection based on a telephone number dialed by the end-user to place the telephone call.

20. The system of claim 16, further operable to perform the step of:
providing the capability for the end-user to manage the personalized content selection.

21. The system of claim 20, wherein the step of providing the capability for the end-user to manage the personalized content selection comprises the step of:
providing the capability for the end-user to manage the personalized content selection over the data communications network.

22. The system of claim 21, wherein the data communications network is the Internet.

23. The system of claim 8, wherein the media delivery interface module is further operable to perform the step of:
controlling access and/or input to the media delivery interface module.

24. The system of claim 23, wherein the step of controlling access and/or input to the media delivery interface module comprises at least one of:
providing password control to establish origination connections;
metering to control, limit, and/or bill based on a length or size of the multimedia content, a number of simultaneous accesses to the multimedia content, a number of total accesses to the multimedia content, a time of access to the multimedia content, and/or periodic charges;
limiting input sources to hardwired connections;
accept connection only from designated sources;
controlling which pieces of content are available based on an access method, login, and/or interconnect;
importing an external permissions file;
providing a sample multimedia content, then requiring billing information to continue providing multimedia content;
blocking specific calling numbers automatically after sample multimedia content has been provided, until payment is made; and
blocking specific calling numbers permanently.

25. The system of claim 24, wherein the media delivery interface module is further operable to perform the step of:
providing advertising content to the end-user.

26. The system of claim 25, wherein the step of providing advertising content to the end-user comprises at least one of:
providing advertising content by class of service;
providing advertising content based on selected multimedia content;
providing advertising content before and/or after providing selected multimedia content; and
providing advertising content based on a timed advertising interval.

27. The system of claim 8, wherein the media delivery interface module is further operable to perform the step of:
requesting the selected multimedia content from a Web server.

28. The system of claim 27, wherein the step of the requesting the selected multimedia content from a Web server comprises the step of:
requesting the selected multimedia content from the Web server using a uniform resource locator.

29. The system of claim 28, wherein the data communications network is the Internet.

30. The system of claim 8, wherein the media delivery interface module is further operable to perform the step of:
requesting the selected multimedia content from a multimedia content server.

31. The system of claim 30, wherein the step of the requesting the selected multimedia content from the multimedia content server comprises the step of:
requesting the selected multimedia content from the multimedia content server using a uniform resource locator.

32. The system of claim 31, wherein the data communications network is the Internet.

33. The system of claim 1, further comprising:
a media acceptance/conversion module operable to provide a physical interface for a plurality of multimedia content feeds and to convert an incoming format of each multimedia content feed into an internal media format.

34. The system of claim 33, wherein a multimedia content feed comprises proprietary content or content not available on the Internet and the system is operable to interface the multimedia content feed through the media acceptance/conversion module for conversion of an incoming format of the multimedia content feed into an internal media format and to relay the converted multimedia content feed to the media delivery interface module for delivery to the end user.

35. The system of claim 34, wherein the incoming format of the multimedia content feed includes at least one of analog voice, digital voice, dial-up telephony via a voice response unit, and Internet Protocol streaming media protocols.

36. The system of claim 33, wherein a multimedia content feed comprises publicly available Internet content and the system is operable to deliver the multimedia content directly to the media delivery interface module for delivery to the end user.

37. The system of claim 33, wherein a multimedia content feed comprises publicly available Internet content and the system is operable to interface the multimedia content feed through the media acceptance/conversion module for conversion of an incoming format of the multimedia content feed into an internal media format and to relay the converted multimedia content feed to the media delivery interface module for delivery to the end user if there are capacity limitations on a source the multimedia content feed, if there are cost advantages, or if the multimedia content is to be stored for future use.

38. The system of claim 33, further comprising:
a media storage module operable to provide temporary storage for multimedia content that is to be stored for future use.

39. The system of claim 38, wherein a multimedia content feed comprises multimedia content to be stored for future use and the system is operable to interface the multimedia content feed through the media acceptance/conversion module for conversion of an incoming format of the multimedia content feed into an internal media format, to store the converted multimedia content in the media storage module, to retrieve the converted multimedia content from the media storage module, and to deliver the retrieved converted multimedia content to the media delivery interface module for delivery to the end user.

40. In a multimedia content interface system for providing multimedia content stored on a data communications network to an end-user over another network, the multimedia content interface system communicatively connected to the data communications network and the other network, a method for providing multimedia content comprising the steps of:
accepting a request for multimedia content from the end-user;
accessing multimedia content over the data communications network;
providing the multimedia content to the end-user over the other network; and
providing an address mapping between an address of multimedia content stored on the data communications network and an address of the end-user on the other network.

41. The method of claim 40, wherein the other network comprises a telecommunications network and the multimedia content is provided to the end-user over a voice channel of the telecommunications network.

42. The method of claim 41, wherein the telecommunications network comprises at least one of a Public Switched Telephone Network (PSTN), a proprietary local telecommunications network, and a proprietary long distance telecommunications network.

43. The method of claim 41, wherein the telecommunications network comprises at least one of a wireless telecommunications network and a wireline telecommunications network.

44. The method of claim 41, wherein the telecommunications network comprises at a wireless telecommunications network and a wireline telecommunications network, which are interconnected.

45. The method of claim 40, wherein the end-user operates an end-user device including at least one of a telephone station and an Internet protocol capable device.

46. The method of claim 40, wherein the end-user operates an end-user device including at least one of a wireless telephone station, a wired telephone station, a personal digital assistant, and a laptop computer.

47. The method of claim 40, wherein the step of accepting a request for multimedia content from the end-user comprises the steps of:
receiving a telephone call from the end-user;
presenting a user interface to the end-user; and
accepting a selection of multimedia content from the end-user.

48. The method of claim 47, wherein the step of providing the multimedia content to the end-user over the other network comprises the step of:
providing the selected multimedia content to the end user.

49. The method of claim 48, wherein the step of presenting a user interface to the end-user comprises the step of:
presenting a different user interface, multimedia content selections, and/or multimedia content to the end-user based on a telephone number dialed by the end-user to place the telephone call.

50. The method of claim 49, wherein the step of providing the selected multimedia content to the end user comprises the steps of:
requesting the selected multimedia content over the data communications network from a source of multimedia content using an indicator of a location of the multimedia content;
receiving over the data communications network the requested multimedia content; and
providing the requested multimedia content to the end-user over the other network.

51. The method of claim 49, wherein there are a plurality of end-users requesting the same multimedia content and the step of providing the selected multimedia content to the end-user comprises the step of:
providing the multimedia content to all end-users that requested the multimedia content.

52. The method of claim 51, wherein the requested multimedia content is live multimedia content and the step of providing the multimedia content to all end-users that requested the multimedia content comprises the step of:
providing the multimedia content to an end-user from a point in the multimedia content at which the end-user requested the multimedia content.

53. The method of claim 51, wherein the requested multimedia content is recorded multimedia content and the step of providing the multimedia content to all end-users that requested the multimedia content comprises the steps of:
providing the multimedia content to an end-user from a point in the multimedia content at which the end-user requested the multimedia content; and
repeating providing the multimedia content from the start of the multimedia content.

54. The method of claim 51, wherein the requested multimedia content is recorded multimedia content and the step of providing the multimedia content to all end-users that requested the multimedia content comprises the step of:
providing the multimedia content from the start of the multimedia content for each end-user that requests the multimedia content.

55. The method of claim 49, wherein the step of presenting a user interface to the end-user further comprises the step of:
presenting a different user interface, multimedia content selections, and/or multimedia content to the end-user based on a telephone number from which the end-user placed the telephone call.

56. The method of claim 48, wherein the step of presenting a user interface to the end-user comprises the step of:
presenting a personalized content selection.

57. The method of claim 56, wherein the step of presenting the personalized content selection comprises the step of:
presenting the personalized content selection based on a telephone number from which the end-user placed the telephone call.

58. The method of claim 56, wherein the step of presenting the personalized content selection comprises the step of:
presenting the personalized content selection based on a telephone number dialed by the end-user to place the telephone call.

59. The method of claim 56, wherein the step of presenting the personalized content selection comprises the step of:
presenting the personalized content selection based on a telephone number dialed by the end-user to place the telephone call.

60. The method of claim 56, further operable to perform the step of:
providing the capability for the end-user to manage the personalized content selection.

61. The method of claim 60, wherein the step of providing the capability for the end-user to manage the personalized content selection comprises the step of:
providing the capability for the end-user to manage the personalized content selection over the data communications network.

62. The method of claim 61, wherein the data communications network is the Internet.

63. The method of claim 48, further comprising the step of:
controlling access and/or input to the media delivery interface module.

64. The method of claim 63, wherein the step of controlling access and/or input to the media delivery interface module comprises at least one of:
providing password control to establish origination connections;
metering to control, limit, and/or bill based on a length or size of the multimedia content, a number of simultaneous accesses to the multimedia content, a number of total accesses to the multimedia content, a time of access to the multimedia content, and/or periodic charges;
limiting input sources to hardwired connections;
accept connection only from designated sources;
controlling which pieces of content are available based on an access method, login, and/or interconnect;
importing an external permissions file;
providing a sample multimedia content, then requiring billing information to continue providing multimedia content;
blocking specific calling numbers automatically after sample multimedia content has been provided, until payment is made; and
blocking specific calling numbers permanently.

65. The method of claim 64, further comprising the step of:
providing advertising content to the end-user.

66. The method of claim 65, wherein the step of providing advertising content to the end-user comprises at least one of:
providing advertising content by class of service;
providing advertising content based on selected multimedia content;
providing advertising content before and/or after providing selected multimedia content; and
providing advertising content based on a timed advertising interval.

67. The method of claim 48, wherein the media delivery interface module is further operable to perform the step of:
requesting the selected multimedia content from a Web server.

68. The method of claim 67, wherein the step of the requesting the selected multimedia content from a Web server comprises the step of:
requesting the selected multimedia content from the Web server using a uniform resource locator.

69. The method of claim 68, wherein the data communications network is the Internet.

70. The method of claim 48, wherein the media delivery interface module is further operable to perform the step of:
requesting the selected multimedia content from a multimedia content server.

71. The method of claim 70, wherein the step of the requesting the selected multimedia content from the multimedia content server comprises the step of:
requesting the selected multimedia content from the multimedia content server using a uniform resource locator.

72. The method of claim 71, wherein the data communications network is the Internet.

73. The method of claim 40, further comprising the steps of:
providing a physical interface for a plurality of multimedia content feeds, and
converting an incoming format of each multimedia content feed into an internal media format.

74. The method of claim 73, wherein a multimedia content feed comprises proprietary content or content not available on the Internet and the method further comprises the step of:
relaying the converted multimedia content feed for delivery to the end user.

75. The method of claim 74, wherein the incoming format of the multimedia content feed includes at least one of analog voice, digital voice, dial-up telephony via a voice response unit, and Internet Protocol streaming media protocols.

76. The method of claim 73, wherein a multimedia content feed comprises publicly available Internet content and the method further comprises the step of:
delivering the multimedia content directly for delivery to the end user.

77. The method of claim 73, wherein a multimedia content feed comprises publicly available Internet content and the method further comprises the steps of:
relaying the converted multimedia content feed for delivery to the end user if there are capacity limitations on a source the multimedia content feed, if there are cost advantages, or if the multimedia content is to be stored for future use.

78. The method of claim 73, further comprising the step of:
providing temporary storage for multimedia content that is to be stored for future use.

79. The method of claim 78, wherein a multimedia content feed comprises multimedia content to be stored for future use and the further comprises the step of:
storing the converted multimedia content;
retrieving the converted multimedia content; and
delivering the retrieved converted multimedia content for delivery to the end user.

80. A computer program product for a multimedia content interface system for providing multimedia content stored on a data communications network to an end-user over another network, the multimedia content interface system communicatively connected to the data communications network and the other network, the computer program product for performing a workflow process in an electronic commerce system, comprising a computer readable medium and computer program instructions, recorded on the computer readable medium, executable by a processor, for performing the steps of:
accepting a request for multimedia content from the end-user;
accessing multimedia content over the data communications network;
providing the multimedia content to the end-user over the other network; and
providing an address mapping between an address of multimedia content stored on the data communications network and an address of the end-user on the other network.

81. The computer program product of claim 80, wherein the other network comprises a telecommunications network and the multimedia content is provided to the end-user over a voice channel of the telecommunications network.

82. The computer program product of claim 81, wherein the telecommunications network comprises at least one of a Public Switched Telephone Network (PSTN), a proprietary local telecommunications network, and a proprietary long distance telecommunications network.

83. The computer program product of claim 81, wherein the telecommunications network comprises at least one of a wireless telecommunications network and a wireline telecommunications network.

84. The computer program product of claim 81, wherein the telecommunications network comprises at a wireless telecommunications network and a wireline telecommunications network, which are interconnected.

85. The computer program product of claim 80, wherein the end-user operates an end-user device including at least one of a telephone station and an Internet protocol capable device.

86. The computer program product of claim 80, wherein the end-user operates an end-user device including at least one of a wireless telephone station, a wired telephone station, a personal digital assistant, and a laptop computer.

87. The computer program product of claim 86, wherein the step of accepting a request for multimedia content from the end-user comprises the steps of:
receiving a telephone call from the end-user;
presenting a user interface to the end-user; and
accepting a selection of multimedia content from the end-user.

88. The computer program product of claim 87, wherein the step of providing the multimedia content to the end-user over the other network comprises the step of:
providing the selected multimedia content to the end user.

89. The computer program product of claim 88, wherein the step of presenting a user interface to the end-user comprises the step of:
presenting a different user interface, multimedia content selections, and/or multimedia content to the end-user based on a telephone number dialed by the end-user to place the telephone call.

90. The computer program product of claim 89, wherein the step of providing the selected multimedia content to the end user comprises the steps of:
requesting the selected multimedia content over the data communications network from a source of multimedia content using an indicator of a location of the multimedia content;
receiving over the data communications network the requested multimedia content; and
providing the requested multimedia content to the end-user over the other network.

91. The computer program product of claim 90, wherein there are a plurality of end-users requesting the same multimedia content and the step of providing the selected multimedia content to the end-user comprises the step of:
providing the multimedia content to all end-users that requested the multimedia content.

92. The computer program product of claim 91, wherein the requested multimedia content is live multimedia content and the step of providing the multimedia content to all end-users that requested the multimedia content comprises the step of:
providing the multimedia content to an end-user from a point in the multimedia content at which the end-user requested the multimedia content.

93. The computer program product of claim 91, wherein the requested multimedia content is recorded multimedia content and the step of providing the multimedia content to all end-users that requested the multimedia content comprises the steps of:
providing the multimedia content to an end-user from a point in the multimedia content at which the end-user requested the multimedia content; and
repeating providing the multimedia content from the start of the multimedia content.

94. The computer program product of claim 91, wherein the requested multimedia content is recorded multimedia content and the step of providing the multimedia content to all end-users that requested the multimedia content comprises the step of:
providing the multimedia content from the start of the multimedia content for each end-user that requests the multimedia content.

95. The method of claim 88, wherein the step of presenting a user interface to the end-user comprises the step of:
presenting a personalized content selection.

96. The method of claim 95, wherein the step of presenting the personalized content selection comprises the step of:
presenting the personalized content selection based on a telephone number from which the end-user placed the telephone call.

97. The method of claim 95, wherein the step of presenting the personalized content selection comprises the step of:
presenting the personalized content selection based on a telephone number dialed by the end-user to place the telephone call.

98. The method of claim 95, wherein the step of presenting the personalized content selection comprises the step of:
presenting the personalized content selection based on a telephone number dialed by the end-user to place the telephone call.

99. The method of claim 95, further operable to perform the step of:
providing the capability for the end-user to manage the personalized content selection.

100. The method of claim 99, wherein the step of providing the capability for the end-user to manage the personalized content selection comprises the step of:
providing the capability for the end-user to manage the personalized content selection over the data communications network.

101. The method of claim 100, wherein the data communications network is the Internet.

102. The computer program product of claim 80, further comprising the step of:
controlling access and/or input to the media delivery interface module.

103. The computer program product of claim 102, wherein the step of controlling access and/or input to the media delivery interface module comprises at least one of:
providing password control to establish origination connections;
metering to control, limit, and/or bill based on a length or size of the multimedia content, a number of simultaneous accesses to the multimedia content, a number of total accesses to the multimedia content, a time of access to the multimedia content, and/or periodic charges;
limiting input sources to hardwired connections;
accept connection only from designated sources;
controlling which pieces of content are available based on an access method, login, and/or interconnect;
importing an external permissions file;
providing a sample multimedia content, then requiring billing information to continue providing multimedia content;
blocking specific calling numbers automatically after sample multimedia content has been provided, until payment is made; and
blocking specific calling numbers permanently.

104. The computer program product of claim 103, further comprising the step of:
providing advertising content to the end-user.

105. The computer program product of claim 104, wherein the step of providing advertising content to the end-user comprises at least one of:
providing advertising content by class of service;
providing advertising content based on selected multimedia content;
providing advertising content before and/or after providing selected multimedia content; and
providing advertising content based on a timed advertising interval.

106. The computer program product of claim 88, wherein the media delivery interface module is further operable to perform the step of:
requesting the selected multimedia content from a Web server.

107. The computer program product of claim 106, wherein the step of the requesting the selected multimedia content from a Web server comprises the step of:
requesting the selected multimedia content from the Web server using a uniform resource locator.

108. The computer program product of claim 107, wherein the data communications network is the Internet.

109. The computer program product of claim 88, wherein the media delivery interface module is further operable to perform the step of:
requesting the selected multimedia content from a multimedia content server.

110. The computer program product of claim 109, wherein the step of the requesting the selected multimedia content from the multimedia content server comprises the step of:
requesting the selected multimedia content from the multimedia content server using a uniform resource locator.

111. The computer program product of claim 110, wherein the data communications network is the Internet.

112. The method of claim 80, further comprising the steps of:
providing a physical interface for a plurality of multimedia content feeds, and converting an incoming format of each multimedia content feed into an internal media format.

113. The method of claim 112, wherein a multimedia content feed comprises proprietary content or content not available on the Internet and the method further comprises the step of:
relaying the converted multimedia content feed for delivery to the end user.

114. The method of claim 113, wherein the incoming format of the multimedia content feed includes at least one of analog voice, digital voice, dial-up telephony via a voice response unit, and Internet Protocol streaming media protocols.

115. The method of claim 112, wherein a multimedia content feed comprises publicly available Internet content and the method further comprises the step of:
delivering the multimedia content directly for delivery to the end user.

116. The method of claim 112, wherein a multimedia content feed comprises publicly available Internet content and the method further comprises the steps of:
relaying the converted multimedia content feed for delivery to the end user if there are capacity limitations on a source the multimedia content feed, if there are cost advantages, or if the multimedia content is to be stored for future use.

117. The method of claim 112, further comprising the step of:
providing temporary storage for multimedia content that is to be stored for future use.

118. The method of claim 117, wherein a multimedia content feed comprises multimedia content to be stored for future use and the further comprises the step of:
storing the converted multimedia content;
retrieving the converted multimedia content; and
delivering the retrieved converted multimedia content for delivery to the end user.
